(19) United States
(12) Patent Application Publication
(10) Pub. No.: US 2019/0362348 A1
(43) Pub. Date: Nov. 28, 2019

(54) MERCHANT ENROLLMENT FOR REVERSE PAYMENTS

(71) Applicant: Visa International Service Association, San Francisco, CA (US)

(72) Inventors: Erick Wong, Vancouver (CA); Jalpesh Chitalia, Castro Valley, CA (US); Karthikeyan Palanisamy, Singapore (SG); Manjush Menon, San Ramon, CA (US); Babara Patterson, South San Francisco, CA (US)

(21) Appl. No.: 16/461,757

(22) PCT Filed: Jan. 3, 2018
(86) PCT No.: PCT/US18/12176

§ 371 Date: May 16, 2019

Related U.S. Application Data
(60) Provisional application No. 62/441,797, filed on Jan. 3, 2017.

(51) Int. Cl. G06Q 20/40; G06Q 20/32; G06Q 20/38

(52) U.S. Cl. CPC G06Q 20/407; G06Q 20/388; G06Q 20/3276

(57) ABSTRACT

Techniques herein describe a method comprising: receiving, at an service provider computer, a resource provider account identifier maintained by an account entity from a resource provider device, the resource provider account identifier being associated with a resource provider; determining, by the service provider computer, if one or more processing networks are capable of processing transactions with the account entity; determining, by the service provider computer, that at least two processing networks of the one or more processing networks is capable of processing transactions with the account entity; and transmitting, by the service provider computer, a resource provider code to at least one of the at least two processing networks, wherein the resource provider code can be used by the least two processing networks to process transactions with the account entity.

### CROSS-REFERENCES TO RELATED APPLICATIONS

This international application claims priority to U.S. Patent Application No. 62/441,797, filed on Jan. 3, 2017, the disclosure of which is herein incorporated by reference in its entirety for all purposes.

### BRIEF SUMMARY

Embodiments of the invention describe systems and methods that allow resource providers to rapidly enroll and conduct push transactions with users utilizing any suitable transaction processing network.

One embodiment of the invention describes a method comprising: receiving, from a resource provider device, a resource provider account identifier maintained by a transport computer with respect to the resource provider; identifying a plurality of processing networks that are capable of processing transactions; determining the transport computer based on the resource provider account identifier; determining that at least two processing networks of the plurality of processing networks are capable of processing transactions with the transport computer; generating a resource provider code that includes at least an indication of the at least two processing networks of the plurality of processing networks; and providing the resource provider code to the resource provider device.

Another embodiment of the invention describes a service provider computer comprising: a processor, and a computer readable medium coupled to the processor, the computer readable medium comprising code executable by the processor to cause the service provider computer to at least: receive, from a resource provider device, a resource provider account identifier maintained by a transport computer with respect to the resource provider; identify a plurality of processing networks that are capable of processing transactions; determine the transport computer based on the resource provider account identifier; determine that at least two processing networks of the plurality of processing networks are capable of processing transactions with the transport computer; generate a resource provider code that includes at least an indication of the at least two processing networks of the plurality of processing networks; and provide the resource provider code to the resource provider device.

Yet another embodiment of the invention describes a method comprising: providing a resource provider code to a resource provider, the resource provider code generated in response to receiving a resource provider account identifier; allowing the resource provider to conduct transactions using the resource provider code; and after allowing the resource provider to conduct transactions using the resource provider code, initiating settlement for the transactions only after the resource provider has been verified.

These and other embodiments of the invention are described in further detail below.

### BRIEF DESCRIPTION OF THE DRAWINGS

Various embodiments in accordance with the present disclosure will be described with reference to the drawings, in which:

FIG. 1 depicts an example interaction that may be implemented between a transactor and a resource provider in accordance with at least some embodiments;

FIG. 2 depicts a diagram of an exemplary service provider computer that may be configured to enable and process push payments across a number of processing networks in accordance with at least some embodiments;

FIG. 3 depicts a diagram illustrating a system that may be implemented according to an embodiment of the invention;

FIG. 4 depicts a flowchart illustrating a method according to an embodiment of the invention;

FIG. 5 depicts a block diagram illustrating a transaction processing system that can be used to perform a push transaction;

FIG. 6 depicts a flowchart illustrating a method for conducting a push transaction in accordance with at least some embodiments;

FIG. 7 depicts a swim lane diagram illustrating a process for enrolling a resource provider in the system described and enabling push payments to that resource provider in accordance with at least some embodiments;

FIG. 8 depicts an illustrative example of an interaction that may occur between various components of the system described herein in accordance with at least some embodiments; and

FIG. 9 depicts a block diagram illustrating a process for generating a code associated with multiple processing networks and conducting a push transaction using that code in accordance with at least some embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Prior to discussing the details of some embodiments of the present invention, description of some terms may be helpful in understanding the various embodiments.

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CW (card verification value), a dCW (dynamic card verification value), a PAN (primary account number or “account number”), a payment token, a user name, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchants access device (e.g. POS equipment) that indicates approval of the transaction. The code may serve as proof of authorization. As noted above, in some embodiments, a transaction processing computer may generate or forward the authorization response message to the merchant.

A “computing device” may be any suitable electronic device capable of communicating with, and/or interacting with other devices. Examples of computing devices may include a mobile phone, a smart phone, a personal digital assistant (PDA), a laptop computer, a desktop computer, a server computer, a vehicle (e.g., an automobile), a thin-client device, a router, a modem, a tablet PC, a printer, etc. Additionally, computing devices may be any type of wearable technology device, such as a watch, earpiece, glasses, etc. The computing device may include one or more processors capable of processing input. The computing device may also provide remote communication capabilities to a network. Examples of remote communication capabilities include using a mobile phone (wireless) network, wireless data network (e.g., 3G, 4G or similar networks), Bluetooth, Bluetooth Low Energy (BLE), Wi-Fi, Wi-Max, or any other communication medium that may provide access to a network such as the Internet or a private network. A computing device may be associated with a username, a password, an electronic identifier, one or more asymmetric keys that may be used for asymmetric encryption, one or more symmetric keys that may be used for symmetric encryption, or the like. A computing device may be configured to access and/or manage a distributed database (e.g., a blockchain).

An “electronic device,” may be any device that accomplishes its purpose electronically. An electronic device may have multiple functions. For example, an electronic device may have a primary function and one or more secondary functions. A primary function may be the function that most closely aligns with the electronic device's purpose. An example of an electronic device may be a machine-to-machine device.

An “issuer” may typically refer to a business entity (e.g., a bank) that maintains an account for a user that is associated with a portable communication device such as an account enrolled in a mobile application installed on a portable communication device. An issuer may also issue account parameters associated with the account to a portable communication device. An issuer may be associated with a host system that performs some or all of the functions of the issuer on behalf of the issuer.

A “merchant” may typically be an entity that engages in transactions and can sell goods or services, or provide access to goods or services.

A “mobile device” may be any computing device capable of traveling with a user. In some embodiments, a mobile device can include any suitable computing device configured to establish communication sessions with one or more electronic devices (including connected devices) and/or a transaction server (either directly or via a processing server). In some embodiments, the mobile device may store one or more account details to be used in these transactions. In some embodiments, the mobile device may be configured to store one or more protocol sets related to transactions and/or connected devices. The mobile device may be further configured to confirm that transactions are in compliance with these transaction protocols prior to initiating the transactions.

A “resource provider” may be an entity that can provide a resource such as goods, services, information, and/or access. Examples of resource providers includes merchants, data providers, transit agencies, governmental entities, venue and dwelling operators, etc.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. Suitable implementations for an operating system and general functionality of the servers are known or commercially available and are readily implemented by persons having ordinary skill in the art, particularly in light of the disclosure herein.

A “transaction” may be any interaction or exchange between two or more parties. For example, a transaction may include a first entity requesting resources from a second entity. In this example, the transaction is completed when the resources are either provided to the first entity or the transaction is declined.

A “transactor” may be any entity attempting to conduct a transaction with a resource provider. In some embodiments, a transactor may be a consumer. For example, a consumer wishing to purchase goods from a merchant would be a transactor.

A “user device” may be a device that is operated by a user. Examples of user devices may include a mobile phone, a smart phone, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

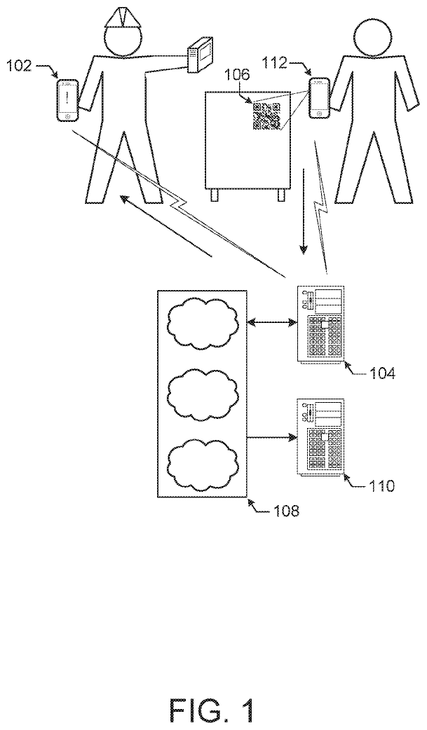

FIG. 1 depicts an example interaction that may be implemented between a transactor and a resource provider in accordance with at least some embodiments. In FIG. 1, a transactor may be any user in the process of acquiring a resource from a resource provider. The resource provider may operate a first transactor user device 102 associated with an account maintained by a service provider 104. A code 106 may be displayed in association with the account maintained by the service provider 104. In addition, the service provider 104 may be in communication with a number of transaction processing networks 108. The transaction processing networks 108 may be capable of approving a transaction and transferring funds to a transport computer 110.

The service provider 104 may be any computing device configured to perform at least a portion of the functions described herein. In particular, the service provider 104 may be a server configured to communicate with one or more user devices and a number of transaction processing networks 108. The service provider 104 may receive a code 106 from a user device along with an indication of an amount of currency and/or an indication of a payment device, and may be configured to cause the amount of currency to be charged to the payment device and transferred to the account,

The code 106 may be any identifier that may be used to identify an account associated with a resource provider. In some embodiments, the code 106 may be a machine readable code capable of being obtained by an electronic device using a code reader. For example, the code 106 may be a quick response (QR) code. In some embodiments, the code may be a short code that includes a string of characters that may be used to identify an account maintained by the service provider 104. In some embodiments, the code 106 may include an indication of which transaction processing networks may be used to conduct a transaction.

The processing networks 108 may include any one or a combination of many different types of networks, such as cable networks, the Internet, wireless networks, cellular networks, and other private and/or public networks. In addition, the processing networks 108 may comprise multiple different networks. In some embodiments, the processing networks 108 may be electronic payment networks (e.g., VisaNet). Additionally, it should be noted that in some embodiments, a processing network 108 may be embodied by one more virtual machines implemented in a hosted computing environment. The hosted computing environment may include one or more rapidly provisioned and released computing resources, which computing resources may include computing, networking, and/or storage devices. A hosted computing environment may also be referred to as a cloud-computing environment.

In some embodiments, the processing networks 108 may each include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network may use any suitable wired or wireless network, including the Internet.

A transport computer 110 may be any computing device or plurality of computing devices configured to process transaction information and/or receive payments into an account associated with the resource provider. In some embodiments, the transport computer 110 may be owned and/or operated by a banking institution (e.g., an acquirer) with which the operator of the resource provider maintains an account.

By way of illustrating interactions between the various components of FIG. 1, consider the following scenario. Upon approaching the resource provider, a transactor wishing to conduct a transaction may be given an amount due for the transaction by the resource provider. The transactor may obtain the code 106 using a second transactor user device 112. The code may then be processed to identify one or more of the transaction processing networks 108 that may be used to conduct the transaction with the resource provider. Upon selection of a transaction processing network 108, the code may be transmitted, along with an indication of a payment device and the amount, to the service provider 104 by the second transactor user device 112.

Upon receiving the indication of the payment device, the amount, and the code 106, the service provider 104 may identify an account associated with the resource provider from the code. The service provider 104 may then submit a request for authorization of the transaction (e.g., an authorization request) to an authorization entity (e.g., an issuer) associated with the payment device for a transaction in the indicated amount. Upon receiving an authorization response form the authorization entity that indicates the transaction is authorized, the service provider 104 may then initiate a payment to the identified account of the resource provider in the indicated amount. The service provider 104 may provide a notification to both the user device 102 of the resource provider 102 and the user device of the transactor 112 indicating that the transaction has been approved.

It should be noted in the example above that the payment device may be selected from a number of payment devices operating across a number of different transaction processing networks. Described below is an enrollment process which a resource provider may use to obtain the ability to receive payments from those payment devices by providing a single account and based on an acquirer and/or credit worthiness of the resource provider.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1. In addition, the components in FIG. 1 may communicate via any suitable communication medium (including the internet), using any suitable communications policy. In at least some embodiments, each component of the depicted architecture may represent one or more special purpose devices configured to perform the described functions. In some embodiments, each component of the depicted architecture may comprise a cluster or group of devices that each perform the same, or a similar, function.

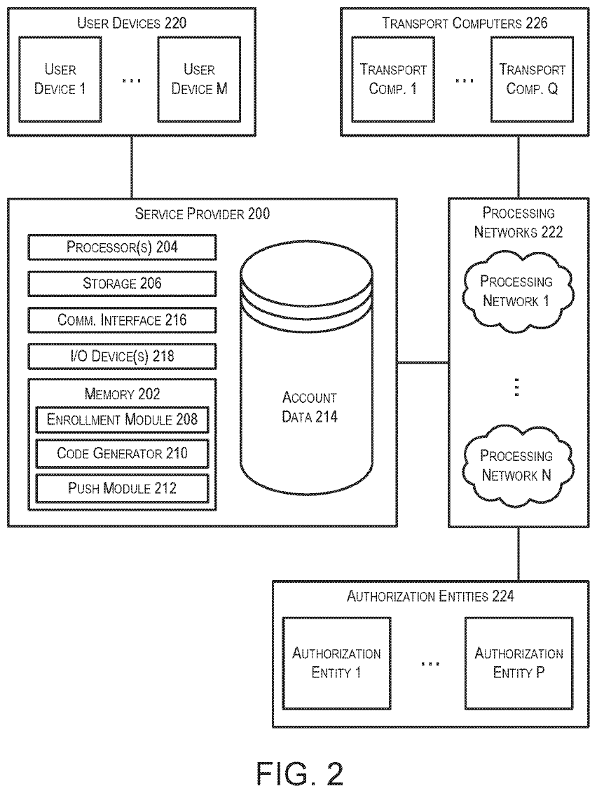

FIG. 2 depicts a diagram of an exemplary service provider computer 200 that may be configured to enable and process push payments across a number of processing networks in accordance with at least some embodiments. The service provider computer 200 may be an example service provider computer 104 described with respect to FIG. 1.

The service provider computer 200 may be any type of computing device capable of identifying an account at a transport computer from a code received from a user device, obtaining authorization for a transaction involving the identified account, and causing funds to be transferred into the account. In at least some embodiments, the service provider computer 200 may include at least one memory 202 and one or more processing units (or processor(s)) 204. The processor(s) 204 may be implemented as appropriate in hardware, computer-executable instructions, firmware or combinations thereof. Computer-executable instruction or firmware embodiments of the processor(s) 204 may include computer-executable or machine executable instructions written in any suitable programming language to perform the various functions described.

The memory 202 may store program instructions that are loadable and executable on the processor(s) 204, as well as data generated during the execution of these programs. Depending on the configuration and type of service provider computer 200, the memory 202 may be volatile (such as random access memory (RAM)) and/or non-volatile (such as read-only memory (ROM), flash memory, etc.). The service provider computer 200 may also include additional storage 206, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the service provider computer 200. In some embodiments, the memory 202 may include multiple different types of memory, such as static random access memory (SRAM), dynamic random access memory (DRAM) or ROM.

Turning to the contents of the memory 202 in more detail, the memory 202 may include an operating system and one or more application programs or services for implementing the features disclosed herein including at least a module for enrolling a resource provider into the described system (enrollment module 208), a module for generating a code that can be used for transacting with the resource provider (code generator 210), and/or a module for processing push transactions using a generated code (push module 212). The memory 202 may also include account data 214, which maintains information associated with individual accounts.

In some embodiments, the enrollment module 208 may, in conjunction with the processor 204, be configured to receive a request for enrollment from a user desiring to open an account (e.g., a resource provider). In some embodiments, the request may include an identity of the user as well as an account identifier for an account maintained at a transport computer (e.g., an acquirer). For example, the request may include a name of the user or the user's business and a bank account number for an account that the user maintains with his or her bank. Upon receiving this request, the enrollment module 208 may identify an acquirer associated with the account based on information included in the account identifier. For example, a bank may be identified based on a banking identification number (BIN) included in the first six digits of the account identifier. In other embodiments, the transport computer may be operated by an issuer of a payment account or a payment card. The payment account or payment card that is issued by the issuer may then be used by a merchant to receive funds. The enrollment module 208 may then identify a number of transaction processing networks 222 which may be used to conduct transactions with the identified account. In some embodiments, the enrollment module 208 may maintain a list of which processing networks may conduct transactions with the identified account. In some embodiments, the service provider 200 may transmit a request to each of a number of processing networks to determine whether individual processing networks are able to process transactions performed with respect to the identified account. In some embodiments, each processing network may provide a response that indicates whether it is or isn't able to complete transactions with respect to the identified account. In some embodiments, the enrollment module 208 may also be configured to perform a know-your-customer (KYC) process upon receiving the request. The KYC process may be performed in parallel to the above described process. In some embodiments, each of the processing networks may perform a KYC process to determine if that processing network is willing to provide payment support to the identified account.

In some embodiments, the code generator 210 may, in conjunction with the processor 204, be configured to receive information from the enrollment module 208 and generate a code to be provided to an enrollee. The information may include an indication of an account number for the enrollee as well as an indication of one or more processing networks that are able to transact with the enrollee (e.g., based on the account information provided). In some embodiments, the code may be a computer generated code such as a barcode or quick response (QR) code. Upon generation of the code, the code generator 210 may be configured to provide the code to a computing device associated with the enrollee (e.g., a user device or personal computer). In some embodiments, the code may be generated as a static code in that the code can be used in any transaction and need not be altered. In some embodiments, the code may be dynamically generated for a particular transaction. For example, the enrollee may provide details of a particular transaction to the service provider 200 and the code generator 210 may generate a code that includes the provided details. The code generated by the code generator 210 may include an indication of the one or more processing networks which have indicated that they can provide payments to the identified account. In some embodiments, the code may comprise a short code, which may be any string of characters, which may be linked to an account maintained by the service provider 200.

In some embodiments, the push module 212 may, in conjunction with the processor 204, be configured to receive an indication of a code from a user device and initiate a payment to an account associated with the code. In some embodiments, the received code may include an account number or other identifier associated with an account maintained by the service provider 200. In some embodiments, the push module 212 may receive an indication of a payment device and an amount of a transaction along with an indication of the account. Upon receiving that information, the push module 212 may be configured to identify a processing network associated with the payment device, generate an authorization request based on the received information, and transmit the authorization request to an authorization entity (e.g., an issuer) of the payment device via the identified processing network. Upon receiving an authorization response indicating that the transaction is authorized, the push module 212 may be further configured to initiate a payment from the authorization entity to the identified account. In some embodiments, the actual payment may be handled by the processing network during a settlement process. In other embodiments, the push module 212 may, in conjunction with the processor 204, perform an AFT/OCT process. This process is described in further detail below,

The service provider computer 200 may also contain communications interface(s) 216 that enable the service provider computer 200 to communicate with a stored database, another computing device or server, one or more remote devices, and/or any other suitable electronic devices. In some embodiments, the communication interface 216 may enable the service provider computer 200 to communicate with other electronic devices on a network (e.g., on a private network). The service provider computer 200 may also include input/output (I/O) device(s) and/or ports 218, such as for enabling connection with a keyboard, a mouse, a pen, a voice input device, a touch input device, a display, speakers, a printer, etc.

The service provider computer 200 may be in communication with a number of user devices 220 (t-M) and/or a number of processing networks 222 (1-N). Each of the processing networks 222, in turn, may be in communication with a number of authorization entities 224 (1-P) and a number of transport computers 226 (1-Q). In accordance with at least some embodiments, each of the processing networks 222 may be payment processing networks which are configured to receive an authorization request that includes an indication of a payment device and a transaction to be conducted using the payment device, determine an appropriate authorization entity based on the payment device, and route the authorization request to the authorization entity. In some embodiments, each of the authorization entities may be issuers of a payment device which are configured to authorize or decline transactions conducted using that payment device.

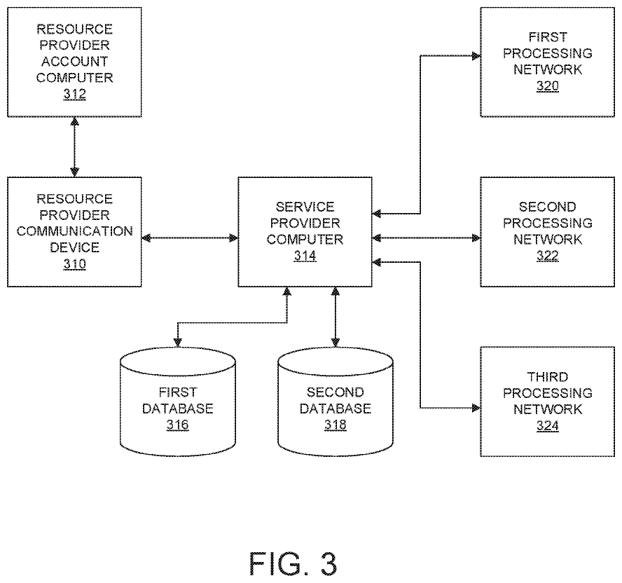

FIG. 3 depicts a diagram illustrating a system that may be implemented according to an embodiment of the invention. The system includes an service provider computer 314, which can be in communication with a resource provider device 310, as well as a number of transaction processing networks. The transaction processing networks may include a first processing network 320, a second processing network 322, and a third processing network 324. The service provider computer may also store and retrieve data from a first database 16 and a second database 318.

The first database 316 may store information such as source provider codes (e.g., short codes) that can identify the resource providers (described in further detail below) to a plurality of different transaction processing networks, as well as resource provider identifiers that are specifically used with a single transaction processing network.

The second database 318 may store various account number, code, or identifier ranges that may be specifically designated for each of the different processing networks 320, 322, 324.

The resource provider device 310 may be operated by a resource provider, which may be associated with an account. The account may have an account identifier. Examples of account identifiers may include credit card, debit card, and stored value card account identifiers. The account may be maintained by a resource provider account computer 312 associated with an account entity such as an acquirer, issuer, or other financial institution.

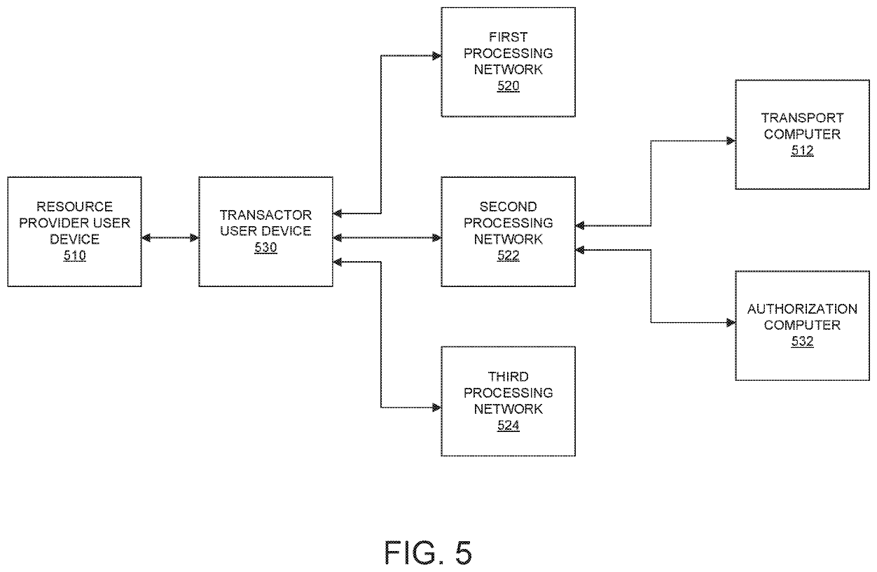

Any suitable number or types of communication networks may be used in the systems described in FIG. 3 (as well as FIG. 5, which is described below). A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

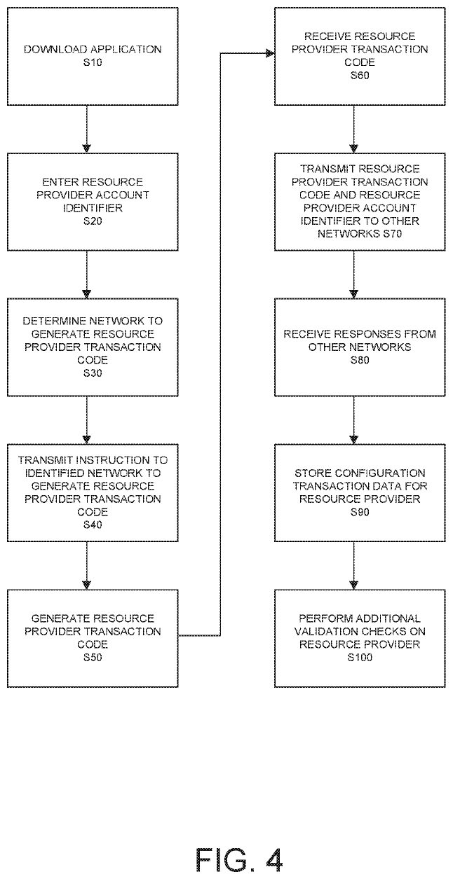

FIG. 4 depicts a flowchart illustrating a method according to an embodiment of the invention. The method can be described with reference to various components depicted in FIG. 3.

In step S10, a resource provider may use the resource provider device 310 and may contact the service provider computer 314. Once they are in communication with each other, an application may be downloaded from the service provider computer 314 to the resource provider device 310. The application may be one that allows the resource provider device 310 to process payment transactions.

In step S20, the resource provider can then enter a resource provider account identifier into the application. The resource provider account identifier can be an account identifier where the merchant wishes to receive payments when conducting transactions with users,

In step S30, the service provider computer 314 can determine which processing network might be best suited to generate a resource provider code such as a short code.

In embodiments of the invention, the service provider computer 314 can provide the resource provider with the necessary data and software which will allow the transport computer to accept payments through transactions that are “pushed” by the users. Such transactions may be referred to as “push transactions.” In push transactions, the resource provider can provide identifying information, and data regarding to the transaction (e.g., the transaction amount, and any other characteristics of the transaction). Once this information is received by a user's transactor user device, the transactor user device may transmit this information along with any user account information (which will be used to pay for the transaction) to a transaction processor computer. The transaction processor computer may then process the transaction using this information.

One way in which the resource provider information may be provided to the user is through the use of a QR code. The QR code can encode merchant identifiers that may be used with one or more transaction processing networks. Sometimes, “short codes” may accompany QR codes. In some embodiments, such short codes may be used by communication devices that may not have the software needed to read and process the QR codes. While a fairly significant amount of data can be included in the OR code, the short code can only carry a limited amount of information. A resource provider specific short code may be usable with a specific transaction processing network. However, without additional processing, it may not be useable with other transaction processing networks, since it may not be able to carry enough data for more than one network to process the transaction. This poses a problem for the resource provider that may want to accept transactions from more than one transaction processing network.

In step S30, the service provider computer 314 may determine if a specific transaction processing network is best suited to generate the resource provider code. In some embodiments, the resource provider account identifier is a demand, credit, debit, or stored value account identifier (e.g., a credit debit, or stored value account number) that is already affiliated with a transaction processing network (e.g., Visa, MasterCard, or Amex). In this case, the service provider computer 314 may determine the affiliated transaction processing network. This can be desirable, because the affiliated processing network can verify that the provided resource provider account number is in good standing. In other embodiments, if the resource provider account identifier is not specifically associated with a transaction processing network, then the service provider computer 314 may choose one transaction processing network out of a plurality of transaction processing networks. The choice may be made based upon any suitable criteria including reliability, transaction processing speed, prior relationships, etc.

In step S40, an instruction is transmitted to the identified transaction network such as the first processing network 320. The instruction may be to generate a resource provider code. The instruction may include the resource provider account identifier and any other suitable information such as the merchant name, location, etc,

In step S50, the identified processing network (e.g., processing network 320) then generates the resource provider code. Prior to doing so, however, the processing network can perform a verification process on the resource provider account to determine that it is legitimate and/or in good standing.

In step S60, in some embodiments, the generated resource provider code is received by the service provider computer 314 from the identified processing network after it has determined that the resource provider account is in good standing, but before a full verification of the resource provider has taken place.

In step S70, the service provider computer transmits the resource provider code to other processing networks along with the resource provider identifier. For example, the code may be transmitted to the second and third processing networks 322, 324 and they may store the code and the resource provider identifier.

In step S80, the service provider computer 314 can receive responses from the other processing networks. The other processing networks may confirm or deny that it is capable of processing and settling transactions with the particular account entity that holds the resource provider account identifier. If a network confirms that it is capable of processing and settling transactions with the particular account entity, then the resource provider can be informed of this and this information can be conveyed to any potential user/customer. If a network states that it is not capable of processing and settling transactions, then the resource provider will be informed of this as well and the resource provider will not offer the network as an option for processing the push payment with its users (e.g., customers).

In step S90, the configuration data as to which networks can interact with the account entity that maintains the account associated with the resource provider account identifier can be stored by the service provider computer 314. Such information may also be transmitted to the resource provider device 310.

In step S100, additional validation checks may be performed on the resource provider. In some instances where the resource provider is new to the entity that holds the resource provider account, or the service provider computer, or the processing networks, additional verification may be required before payments can be received in the account associated with the resource provider account identifier. In the instruction to the network that generated the code, other information such as the merchant location and merchant name can be verified. This may be similar to “know your customer” or KYC checks that are performed in the financial industry. This additional verification process may take some time. However, in embodiments of the invention, a resource provider can still conduct transactions even though this additional verification processing has not been completed. Transactions can be conducted, but actual funds will not be transferred to the resource provider until the additional verification processing will be completed. This advantageously allows resource providers to conduct transactions almost immediately, without waiting for KYC type verification processes to complete. Fraudulent merchants would not likely participate in such a process, because they would be giving resources to users with the risk that they might not receive actual funds when it is determined that they are actually fraudulent merchants.

FIG. 5 depicts a block diagram illustrating a transaction processing system that can be used to perform a push transaction. In FIG. 5, a transactor user device 530 may interact with a resource provider device 510 during a transaction such as a push payment transaction. For example, the transactor user device 530 may obtain a code from the resource provider user device to be used in completing a transaction. In this example, the code may be transmitted wirelessly between the two devices or the code may be scanned from a display of one of the devices using a camera of the other device. The transactor user device 530 may be capable of being in communication with the first, second, and third processing networks 520, 522, 524. For purposes of illustration, the transport computer 512 and an authorization computer 532 are shown as being in communication with the second processing network 522. The authorization computer 532 can be operated by an entity (e.g., an issuer) that maintains an account of the user.

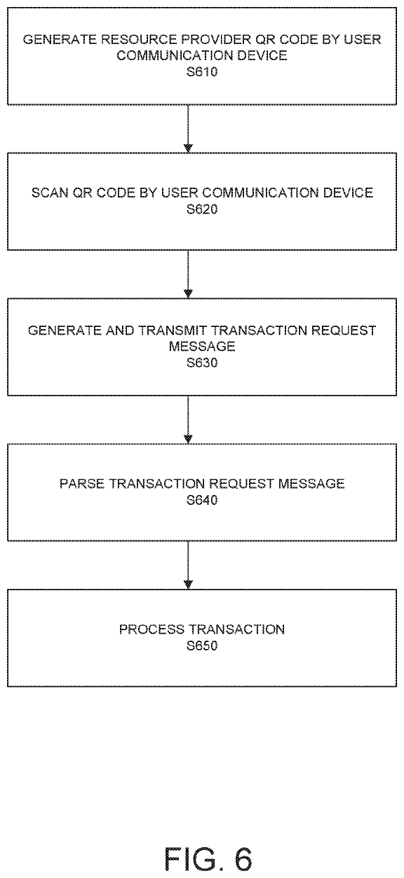

FIG. 6 depicts a flowchart illustrating a method for conducting a push transaction in accordance with at least some embodiments. Reference can also be made to the system diagram in FIG.

In step S610, a resource provider device 510 can generate a QR code after the user of the transactor user device 530 makes a decision to purchase goods or services from the resource provider.

In step S620, the transactor user device 530 scans or otherwise obtains the QR code or the data encoded by the OR code.

In step S630, the transactor user device 530 then generates and transmits a transaction request message to a processing network such as the second processing network 522. The transaction request message may contain the information coded by the OR code and/or a short code including a transaction amount, the previously described merchant short code identifier, and any other suitable information needed to facilitate the transaction. It may also include a payment account number that is used by the user to pay for the goods and services. In this example, the resource provider account identifier may be specifically affiliated with a first payment processing network 520 while the users account identifier may be specifically affiliated with the second payment processing network 522. In embodiments of the invention, transactions can be conducted despite this difference.

In step S640, once the transaction request is received by the second processing network 522, the second processing network may parse the transaction request message to obtain the data included in it.

In step S650, using the previously described data in the QR code and/or short code, and the payment account number of the user, the second processing network 522 can process the transaction. In particular, the second processing network 522 may facilitate the appropriate crediting of the resource provider account at the transport computer 512 and the debiting of the user account at the authorization computer 532. It may also facilitate the settlement of funds between the user account and the resource provider account. Crediting and debiting may occur through the use of OCT (original credit transactions) and AFT (account funding transactions) transaction messages, or through any other suitable type of message.

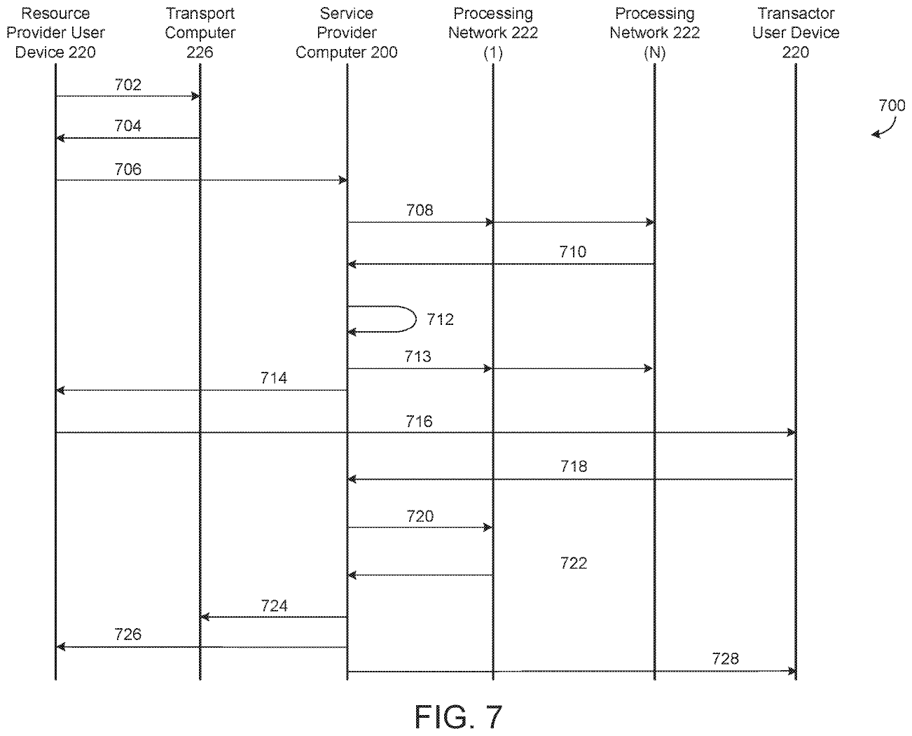

FIG. 7 depicts a swim lane diagram illustrating a process for enrolling a resource provider in the system described and enabling push payments to that resource provider in accordance with at least some embodiments. The process 700 is illustrated as a logical flow diagram, each step of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement this process and any other processes described herein.

Depicted in FIG. 7 is an illustrative example of one or more interactions that may occur between various components of the system described herein in accordance with at least some embodiments. In particular, FIG. 7 illustrates a process 700 that may be performed which may involve a resource provider resource provider user device 220, a transport computer 226, a service provider 200, multiple processing networks 222 (1-N), and a transactor resource provider user device 220. Each of these components is described in more detail with respect to FIG. 2. Some or all of the process 700 (or any other processes described herein, or variations and/or combinations thereof) may be performed under the control of one or more computer systems configured with executable instructions and may be implemented as code (e.g., executable instructions, one or more computer programs or one or more applications). In accordance with at least one embodiment, the process 700 of FIG. 7 may be performed by at least the service provider computer 200 described with respect to FIG. 2. The code may be stored on a computer-readable storage medium, for example, in the form of a computer program including a plurality of instructions executable by one or more processors. The computer-readable storage medium may be non-transitory.

Prior to the initiation of process 700, a resource provider may open an account with a transport computer 226. In some embodiments, the transport computer 226 may be a financial institution, such as a bank (e.g., an issuer or acquirer). The resource provider may submit a request to the transport computer 226 at 702 that includes a number of details related to the user (e.g., demographic information, etc.). The transport computer 226 may then analyze the provided information in order to determine whether to grant the resource provider an account (e.g., a checking or savings account). Upon determining that the resource provider may be granted an account, the transport computer may provide an account number to the resource provider resource provider user device 220 at 704. It should be noted that a transport computer 226 typically performs a KYC process for each user that requests an account. This may involve the transport computer 226 performing a credit check or some other authorization. Hence, that a resource provider has obtained an account with a transport computer 226 may provide some level of assurance that the resource provider is credit worthy.

Process 700 may begin at 706, when a resource provider requests enrollment in the system described herein. The resource provider may provide his or her account number to the service provider 200 which was obtained from the transport computer 226. In some embodiments, the resource provider may also provide a number of other details related to the resource provider. In some embodiments, the enrollment request may be for a one-time use transaction. For example the resource provider may request a code be generated that will allow one other party to make a payment to the resource provider. In this example, the resource provider may provide an amount for which the transaction should be conducted, an indication of resources provided in the transaction, a transaction number, or any other suitable transaction-related information. In some embodiments, the enrollment may be related to a request for a static code (e.g., an unchanging code) that may be used by a number of transactors in a number of different transactions.

Upon receiving the enrollment request, the service provider 200 may determine which processing networks 222 of a plurality of processing networks are able to provide payment to the account. In some embodiments, the service provider 200 may maintain a list of which processing networks are capable of providing payment to any particular transport computer. In some embodiments, the service provider 200 may generate a number of requests to the processing networks 222 (1-N), such that each request is generated for a different processing network. The requests may include an indication of the resource provider's account with the transport computer as well as any other suitable information related to the resource provider. The generated requests may be transmitted to each of the processing networks 222 at 708.

At 710, the service provider 200 may receive a number of responses from one or more of the processing networks that indicates whether or not that processing network can provide payment to the account associated with the resource provider. In some embodiments, the processing network 222 may determine whether it can provide payment to the resource provider's account upon determining that the processing network 222 has a relationship with the transport computer 226. In some embodiments, the processing network may perform a KYC or credit worthiness analysis of the resource provider before determining whether or not to provide payment to the resource provider's account.

At 712, the service provider 200 may compile a list of each of the processing networks capable of providing payments to the account at the transport computer. Once the service provider has determined which processing networks are capable of providing payment to the resource provider, the service provider 200 may generate a code that includes a number of details related to the resource provider. The code may also include an indication as to which processing networks can be used to provide payment to the transport computer. In some embodiments, the code may be a machine-readable code such as a bar code or QR code. In some embodiments, the code may be a short code, which may be a string of characters which is associated with an account maintained by the service provider. In some embodiments, at least a portion of a short code may identify the processing networks capable of being used to provide payment to a resource provider, and at least a second portion of the code may reference an account of the resource provider. The service provider 200 may transmit the generated code to the resource provider's resource provider user device 220 at 714. In some embodiments, the service provider may also transmit the code to each of the processing networks at 713.

The resource provider may display the received code in relation to his or her business. In some embodiments, the code may be displayed as astatic code which is printed and placed so that it can be scanned by a user device of a potential transactor. In some embodiments, the code may be provided to a user device of the resource provider so that it can be displayed upon a display of that user device. The potential transactor may enter the code into his or her user device at 716. For example, the transactor may manually enter the code into an input screen of the user device if the code is a string of characters. In another example, the transactor may scan the code if the code is a machine readable code. In some embodiments, the code may include an indication of each of the different processing networks that may be used to provide payment to the service provider. Once entered, the code may be caused to be sent to the service provider at 718 within a payment request. The payment request may also include an indication of a payment device to be used in completing a transaction. It should be noted that in some embodiments, rather than being transmitted to the service provider, the payment request may be transmitted directly to the processing network by the transactor user device. In these embodiments, the processing network may be caused to push a payment into the indicated account. The processing network may then communicate the completion of a particular payment to the service provider based on the service provider having earlier provided the generated code to the processing network.

Upon receiving the code from the transactor's user device, the service provider 200 may identify a payment device associated with the payment request. In some embodiments, an indication of the payment device may be stored in association with an account maintained with respect to the transactor's user device. In some embodiments, an indication of the payment device may be included in the payment request. For example, the transactor may, using a graphical user interface on his or her user device, select a credit card, bank account, token service (e.g., an e-wallet application), or any other suitable source of funds. Upon selection of the payment device by the user, the payment request may be generated to include the payment device as well as the resource provider's account.

Once the service provider has identified the payment device from which a payment is to be made, the service provider may identify an authorization entity to approve the transaction. In some embodiments, the authorization entity may be determined based on a format of an account number associated with the payment device. For example, the account number may include a banking identification number (BIN) which may indicate a financial institution that authorizes transactions conducted using the payment device. The service provider may then generate an authorization request message for the transaction, which it may then transmit to the identified authorization entity such as an issuer (not shown) over an appropriate processing network at 720.

At 722, the authorization entity may respond to the service provider with an authorization response indicating whether the transaction is approved or declined. Upon determining that the transaction has been approved, the service provider may initiate a transfer of funds from the authorization entity to the resource provider's account with the transport computer at 724. Additionally, the service provider may provide a notification to the resource provider at 726 and/or a notification to the transactor at 728 to indicate that the transaction has been completed.

In other embodiments of the invention, an AFT/OCT process can be used. In an AFT/OCT process, an AFT message is first sent by a service provider to a payer's bank. After the AFT message is approved by the payer's bank (e.g., an issuer in communication with the service provider computer 200 in FIG. 7), the service provider transmits an OCT message to the payee's bank (e.g., the transport computer 226 in FIG. 7). A clearing and settlement process occurs at a later time. In some cases, the AFT/OCT process can be used in cases where the payer and the payee banks are both issuers of payment cards. The payee can have a payment card that can be used to both make and receive payments.

An AFT (Account Funding Transaction) is a transaction designed to supply funds to another account such as a credit, prepaid, debit, ATM or on-line account. In embodiments of the invention, an AFT is paying a service provider for sending funds to the recipient and results in a debit to a sender's account (e.g., a payment card account). The amount of the debit is the amount of the credit to be delivered to the recipient plus any fees being charged by the service provider such as a transfer fee, or a currency conversion fee when the money transfer portal performs currency exchange and its acquirer submits the transaction in the preferred currency of the recipient.

An AFT indicator can used in both the authorization and clearing and settlement transactions and is preceded by an authorization. Settlement can take place within two working days. Neither the authorization nor the clearing transaction carries any financial information about the recipient of a money transfer. The AFT carries only the account number associated with the payment card or account of the sender. An AFT is also accompanied by indicators, which allow the sender's card issuing bank to take appropriate authorization decisions. Indicators include channel information such as Mail Order/Telephone Order or Internet, and merchant type. A financial services association (such as Visa) can perform currency conversion on AFT transactions when the currency of the sender is different from the currency accepted by the service provider. AFT indicators are used to show funds transfers instead of standard purchase transactions. The following can be key fields used for an AFT and can be supported in messages and clearing and settlement transactions. The key fields are: Processing Code; Merchant Type; CAW Result Code; Mail Order/Telephone Order/Electronic Commerce Indicator; Mail/Phone/Electronic Commerce Indicator; Transaction ID (XID); and CAW Data.

An OCT (Original Credit Transaction) is typically a clearing and settlement credit transaction designed for use in business applications such as a business money transfer or business-to-consumer repayments. When used in the context of the present invention for money transfer, the OCT is the transaction used to deliver funds to the recipient account. It is separate from, and takes place after, the AFT transaction. This timing is to ensure that payment funds are secured before funds are sent to the recipient.

The amount of the OCT is the amount agreed by the sender and the service provider in the currency agreed. If the recipient's billing currency is different from the currency agreed at the transaction time, currency conversion is performed on the OCT and the exact amount credited to the recipient account will not be known at transaction time. In some embodiments, the OCT carries only the account number of the recipient and no information about the sender. A special indicator identifies an OCT to the recipient's issuer bank. Interchange can flow from the submitting acquirer to the recipient's issuer, as in a normal purchase transaction. Settlement can take place within a few days.

It should be noted that the service provider, the processing network, and/or the transport computer may each assess the suitability of the resource provider for participation in the system described herein. In some embodiments, the service provider may, upon receiving the indication of the resource provider's account at 706, identify each of the processing networks capable of providing payment to the transport computer and may generate an initial code based on the identified processing networks. The service provider may then perform a KYC process or other credit check after providing the code to the resource provider at 714. In some embodiments, a transaction initiated using the process described herein may not be completed until the KYC process has been successfully completed.

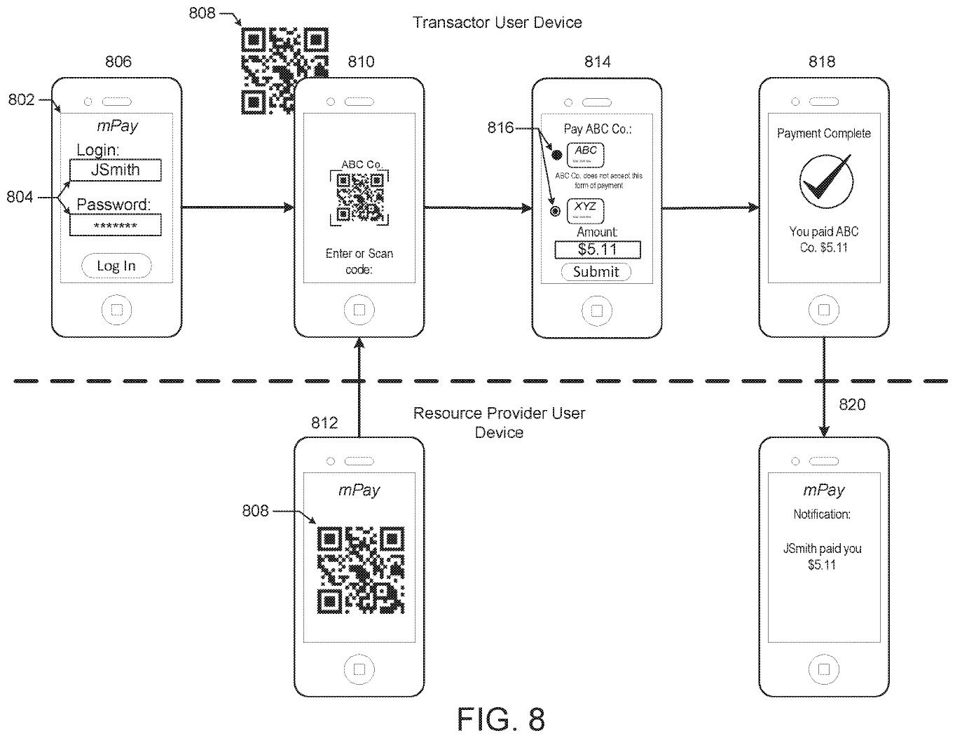

FIG. 8 depicts an illustrative example of an interaction that may occur between various components of the system described herein in accordance with at least some embodiments. In FIG. 8, the system may include at least two user devices. The user devices depicted include a transactor user device, which may be associated with a potential transactor, and a resource provider user device, which may be associated with a potential resource provider. Each of the user devices may include a display and instructions that cause the user device to execute at least a portion of the functionality described herein. The instructions may take the form of a mobile application which is installed upon, and executed from, the respective user device. The mobile application may include a graphical user interface (GUI) 802 which enables a user to interact with the system. In some embodiments, the mobile application may cause the user device to communicate with a remote server that performs at least a portion of the functionality described herein.

In some embodiments, a user of the transactor user device may be required to log into an account maintained with respect to the mobile application via the GUI 802. For example, the GUI may require that the user enter a login and password 804. Upon logging into the account of the mobile application at 806, the mobile application may cause the user device to activate a camera device or another suitable input device in order to enable the user device to capture a code 808. For example, as depicted at 810, the code 808 may be a machine readable code which is scanned as input by the user device using a barcode reader or camera device installed in the transactor user device. In some embodiments, the code 808 may be displayed upon the resource provider user device in order to be scanned by the transactor user device as depicted at 812.

Once the code 808 has been obtained by the transactor user device, the mobile application may parse the information in the code to determine which processing networks may be used to complete a transaction. In some embodiments, the processing networks that may be used to complete a transaction with a particular resource provider may be determined from information included in, and/or a format of, the code 808. In some embodiments, the mobile device may present an option to select a payment device from a number of payment devices available to a user at 814. In some embodiments, the mobile application may display a number of payment devices associated with the user and may provide an indication 816 of which payment devices are supported based on information included in the code 808. For example, the code may include a string of characters that, when translated, indicates that the resource provider can be paid using Visa or MasterCard processing networks. In this example, a Visa payment card associated with the user may be indicated as being useable whereas an American Express payment card associated with the user may be indicated as not being useable. In some embodiments, only the payment devices which are determined to be useable are displayed to the user. In some embodiments, the user may not be presented with any payment device options. For example, the payment device to be used to complete a payment may be stored by the service provider in association with an account maintained by the service provider. In this example, the service provider, upon the initiation of a payment using the system described herein, may select an appropriate payment device using configuration settings or preferences set by a user. For example, the service provider may initiate the payment using a most preferred payment device which is able to provide payment to the resource provider.

The user may be prompted to enter an amount of the transaction at 814. An indication of the payment device as well as the amount may be transmitted to the service provider upon the user selecting an option to initiate the payment (e.g., a submit button). The process performed by the service provider upon receipt of this information is described elsewhere. Upon the initiation of the payment transaction by the service provider (e.g., after receiving a response from an authorization entity that the transaction is authorized), the service provider may provide a notification to the transactor at 818 and/or provide a notification to the resource provider at 820 indicating that the transaction has been completed. In some embodiments, the resource provider may provide access to a resource requested by the transactor upon receiving the notification.

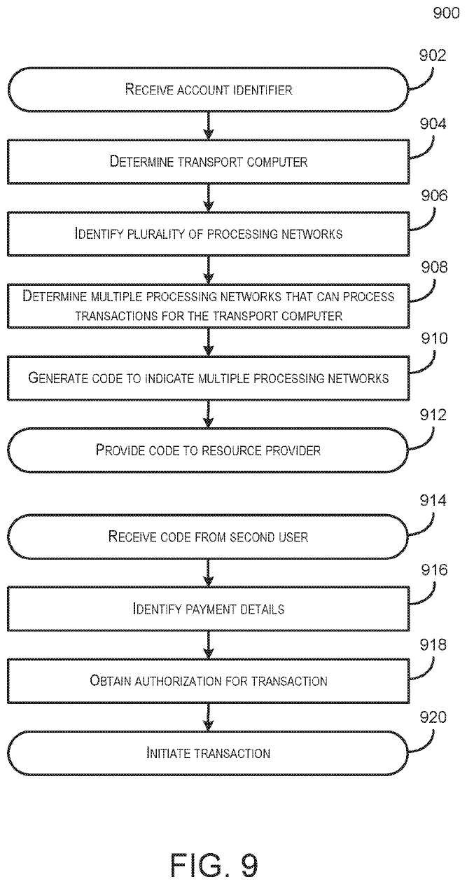

FIG. 9 depicts a block diagram illustrating a process for generating a code associated with multiple processing networks and conducting a push transaction using that code in accordance with at least some embodiments. The process 900 may be performed by the service provider 200 described in FIG. 2.

Process 900 may begin at 902, when a request is received to enroll in the described system. In some embodiments, the request may include at least an account identifier for an account of a resource provider which is maintained by a transport computer (e.g., a computer operated by a financial institution, such as a bank). The request for enrollment may also include a number of other details, such as demographic or financial information for the resource provider that may be used to assess a credit worthiness of the resource provider. In some embodiments, the service provider may identify the transport computer at 904 based upon the provided account identifier. For example, the resource provider may provide his or her bank account number and the service provider may determine which transport computer is affiliated with that account number based on a banking identification number (BIN) included in the account identifier.

At 906, the service provider may identify a number of processing networks that are capable of providing payments to various transport computers. For example, the service provider may maintain a database in which such processing networks are identified. Additionally, the service provider may maintain a secure egress, or access, point to each of the processing networks. Upon identifying the transport computer, the service provider may identify which processing networks of the number of processing networks available are able to provide payment to the identified transport computer at 908. In some embodiments, this may involve accessing database entries associated with each of the processing networks to determine which transport computers have agreements in place with, or are structurally capable of receiving payments from, a particular processing network. In some embodiments, the service provider may generate and transmit a request to each of the available processing networks that includes at least an indication of the transport computer, as well as any information that may be needed by the processing network to determine whether the transport computer can be supported by that processing network. The service provider may then receive responses from each of the processing networks to which it transmitted a request indicating whether or not that processing network can support payments to the account at the transport computer. From these responses, the service provider may compile a list of processing networks that can provide payment to the account associated with the received account identifier.

At 910, the service provider may generate a code for the resource provider. In some embodiments, the code may be generated such that it includes an indication of each of the processing networks capable of providing payment to the account at the transport computer. In some embodiments, the indication of each processing network may include a string of characters. For example, because each processing network can be treated as a binary (i.e., either the processing network can support payment to the account or it cannot), the code may include a string of binaries that may be converted into a character. For example, if processing networks A, B, C, and D are all available, but only processing network A, B, and C are capable of supporting payment to a particular transport computer, then each of processing networks A-D may be assigned a place within a binary string such that 1110 represents the described situation (with processing network A represented in the leftmost position followed by order of each letter). In this example, the nibble (half of a byte) can be represented by the value “E” (i.e., 1110 is binary for fifteen, which converts to E in hexadecimal). Hence, the character E could be used to indicate that processing networks A, B, and C are each able to be used in completing a transaction with this resource provider. In this example, the value E may be placed within the generated code at a particular position in order to enable quick identification of the processing networks that can be used to conduct the transaction.

The code may be any string of characters capable of being used by the service provider to identify the resource provider's account. In some embodiments, the code may include the resource provider's account. In some embodiments, the code may be a short code that includes a relatively short string of characters that is linked to an account by the service provider. A short string may include the indication of the processing networks that may be used, as discussed above, but may also include a series of characters that are not able to be translated into a particular account. For example, the service provider may maintain a list of character strings (which may be generated randomly) which are each associated with a different account via a database mapping. In some embodiments, the code may be translated into a machine-readable code such as a bar code or QR code. Once the code has been generated, the service provider may provide the code to the resource provider at 912. In some embodiments, the service provider may provide the code to each of the processing networks capable of providing payment to the account at the transport computer. This enables each processing network to independently receive payment requests related to the resource provider and process those payment requests by pushing a payment to the service provider or the account at the transport computer.

Process 900 may continue at 914, when the code is received from a second user device within a payment request. In some embodiments, the payment request may be received by a service provider. In some embodiments, the payment request may be received by one of the processing networks indicated as being capable of providing payment to the transport computer. In some embodiments, the payment request may include a number of information related to a transaction to be conducted with the resource provider. For example, the code may be received from a consumer that wishes to complete a purchase from the resource provider. In this example, the consumer may scan the code as it is displayed by the resource provider, select a payment device, enter an amount of the transaction, and submit the transaction for approval to the service provider. In this example, the service provider may also maintain an account associated with the consumer.

Upon receiving the payment request, the service provider may identify the resource providers account based on the code included in the payment request. The service provider may also identify a payment device associated with the request at 916. In some embodiments, the payment request may include an account identifier for the payment device to be used in completing the transaction. In some embodiments, the payment device may be selected from one or more payment devices stored in association with an account maintained by the service provider with respect to a user from which the payment request originated. For example, the service provider may identify the user that submitted the payment request based on a phone number or login information. Once the user has been identified, the service provider may identify payment devices associated with that user. In some embodiments, the service provider may select a single payment device from multiple payment devices available to the user based on a number of factors (e.g., miles or rewards, credit limits, penalties, etc.).

At 918, the payment request may be authorized. To do this, an authorization entity associated with the payment device may receive an indication of the payment request and may approve or decline the transaction based on a credit limit associated with the payment device, potential fraud risks associated with the transaction, or various other transaction-related details. In some embodiments, the service provider may receive the payment request and may generate an authorization request based on the transaction information and payment device indicated in the payment request. The authorization request may then be transmitted over an appropriate processing network to the authorization entity associated with that payment device. In these embodiments, the service provider may initiate a transfer of funds to the account of the resource provider upon approval of the transaction by the authorization entity at 920. In other embodiments, the payment request may be received by the processing network, which may then generate an authorization request to be transmitted to the appropriate authorization entity. In these embodiments, the processing network may initiate a transfer of funds to the account of the resource provider upon approval of the transaction by the authorization entity at 920. Once the payment has been initiated, the service provider may notify one or more of the resource provider and the user that initiated the payment request.

Embodiments of the disclosure provide for a number of technical advantages over conventional systems. For example, conventional payment systems often require that an applicant (e.g., a resource provider) submit to a lengthy application process. In this application process, the user (or his or her acquirer) is often required to separately request support from each processing network that the user desires to use. This typically results in the user maintaining a number of different accounts at a transport computer (e.g., an acquirer), one for each separate processing network that supports the user. This also results in the applicant being unable to receive any payments until the application process has been completed, which can take days or even weeks. Conventional systems also often require that the applicant purchase special equipment to process transactions, which can be expensive. These flaws in conventional payments systems usually have a greater impact on small vendors than on large corporations.

The system described herein solves a number of problems in conventional payment systems in that it enables a resource provider to quickly establish a payment means using only his or her bank account number. The system is able to provide a code to an applicant within minutes that allows that applicant to start accepting payments right away without the need to purchase any equipment. By performing the KYC process after providing the code, but before initiation of a payment, the system is able to drastically speed up the enrollment process while retaining a number of security features inherent in conventional systems. The system also enables an applicant to accept payment from a number of different processing networks via a single point of access, which conventional payment systems are not able to do.

Furthermore, by using the short code according to embodiments of the invention, a merchant that has an account can be assured that that account can receive payments from certain networks associated with certain payment devices. For example, the account may be a checking account with a particular bank. If the merchant wants to start receiving credit card payments in that checking account, it cannot be sure that any and all networks associated with any and all credit cards can settle with or otherwise interact with that checking account at that particular bank. Thus, by using the short code, each processing network has confirmed to a central service provider that it can settle with or otherwise interact with that checking account. Consequently, can ensure that the merchant's account can receive payments from certain payment cards associated with certain networks, without having to take the time to establish a formal relationship with each processing network that it wants to interact with.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, at a service provider computer from a resource provider device, a resource provider account identifier maintained by a transport computer with respect to the resource provider;
identifying, by the service provider computer, a plurality of processing networks that are capable of processing transactions;
determining the transport computer based on the resource provider account identifier;
determining, by the service provider computer, that at least two processing networks of the plurality of processing networks are capable of processing transactions with the transport computer;
generating a resource provider code that includes at least an indication of the at least two processing networks of the plurality of processing networks; and
providing the resource provider code to the resource provider device.

2. The method of claim 1, further comprising:
receiving a payment request that includes the resource provider code from a second user device;
identifying, within the payment request_{;} a payment device associated with one of the at least two processing networks;
generating an authorization request message to an authorization entity associated with the payment device; and
transmitting the authorization request message to the authorization entity via the one of the at least two processing networks.

3. The method of claim 2, further comprising:
receiving an authorization response from the authorization entity via the one of the at least two processing networks; and
upon determining, from the authorization response, that the payment request is authorized, initiating a payment transaction indicated within the payment request.

4. The method of claim 3, further comprising upon initiating the payment transaction, providing a notification to at least one of the resource provider device or the second user device.

5. The method of claim 1 wherein determining if the one or more processing networks is capable of processing transactions with the transport computer comprises determining that the resource provider account number is affiliated with a specific processing network, the specific processing network being one of the at least two processing networks.

6. The method of claim 1, further comprising providing the code to each of the at least two processing networks of the plurality of processing networks.

7. The method of claim 6, further comprising causing a payment request to be transmitted to one of the at least two processing networks by a second user device that based on having received the code, wherein the payment request is routed to an authorization entity by the one of the at least two processing networks.

8. The method of claim 7, further comprising receiving a notification from the one of the at least two processing networks indicating that the payment request has been processed.

9. The method of claim 1, wherein the resource provider code is a short code that is linked to the resource provider account at the service provider.

10. The method of claim 1, wherein the resource provider code is a machine-readable code.

11. The method of claim 1, wherein the resource provider account identifier is a credit, debit, or prepaid card account number.

12. A service provider computer comprising:
a processor; and
a computer readable medium coupled to the processor, the computer readable medium comprising code executable by the processor to cause the service provider computer to at least:
receive, from a resource provider device, a resource provider account identifier maintained by a transport computer with respect to the resource provider;
identify a plurality of processing networks that are capable of processing transactions;
determine the transport computer based on the resource provider account identifier;
determine that at least two processing networks of the plurality of processing networks are capable of processing transactions with the transport computer;
generate a resource provider code that includes at least an indication of the at least two processing networks of the plurality of processing networks; and
provide the resource provider code to the resource provider device.

13. The service provider computer of claim 12, wherein the resource provider device is a mobile phone.

14. The service provider computer of claim 12, wherein the resource provider code is a QR code.

15. The service provider computer of claim 14, wherein the resource provider code can be printed by the resource provider and displayed.

16. The service provider computer of claim 12, wherein the transport computer is determined based on a BIN included in the resource provider account identifier.

17. The service provider computer of claim 12, wherein the plurality of processing networks are stored in a database by the service provider computer.

18. A method comprising:
providing a resource provider code to a resource provider, the resource provider code generated in response to receiving a resource provider account identifier;
allowing the resource provider to conduct transactions using the resource provider code; and
after allowing the resource provider to conduct transactions using the resource provider code, initiating settlement for the transactions only after the resource provider has been verified.

19. An service provider computer comprising a processor and a computer readable medium, the computer readable medium comprising code for performing the method of claim 18.
